(19) United States
(12) Patent Application Publication
(10) Pub. No.: US 2020/0112920 A1
(43) Pub. Date: Apr. 9, 2020

(54) COMPLIANT RADIO AND METHOD OF USE

(71) Applicant: California Eastern Laboratories, Inc., Santa Clara, CA (US)

(72) Inventor: David E. Wilde, Cary, IL (US)

(73) Assignee: California Eastern Laboratories, Inc., Santa Clara, CA (US)

(21) Appl. No.: 16/152,503

(22) Filed: Oct. 5, 2018

(51) Int. Cl. H04W 52/02; H04L 29/08; H04L 12/66; H04B 1/48; H04B 1/00

(52) U.S. Cl. CPC H04W 52/0235; H04L 67/12; H04W 84/12; H04B 1/48; H04B 1/006; H04L 12/66

(57) ABSTRACT

A high-powered ISM band radio board includes a microprocessor, a radio transceiver coupled to the microprocessor, a timer crystal coupled to the radio transceiver, and a low-pass filter coupled to the radio transceiver. A transmission and reception line extends from the radio transceiver and terminates at an antenna and a transmission line stub extends from the transmission and reception line at a first end of the stub, has a length of one-quarter of a wavelength of a third harmonic of a signal output by the radio, and is open at a second end opposite the first end.

### BACKGROUND

### Field of the Disclosure

The present disclosure generally relates to local area network (LAN) radios, and more particularly to radios for nodes on a local area network that operate in the industrial, scientific and medical (ISM) radio bands, typically around the 2.4 GHz radio frequency range, and are compliant with the FCC requirement that the third harmonic of a radio transmission be limited to 54 dBuV/m.

### Brief Description of Related Art

Radios are required to enable wireless communication. Those radios receive or transmit messages between wireless devices in various systems, including Internet of Things and control system networks and the component parts of those systems, including sensors, actuators, and controllers.

Radios are required not to have more than 54 dBuV/m power output in their harmonics if the harmonics fall within a restricted band. To meet that requirement, the fundamental output power of these radios is often decreased until the radio's harmonic output power is not greater than 54 dBuV/m. That reduction in fundamental power output by the radio can cause a transmitted signal carrying information to be transmitted to another node, for example, to be weak, so weak that it may not be received by a receiving node that requires the transmitted information.

One solution people use for such a problem of a signal not being received is to increase the fundamental power output of a radio. Such an increase in fundamental output power may frequently cause the radio to have a higher harmonic output power than the permitted 54 dBuV/m, often at the third harmonic of the transmission. Because that common solution often creates an illegal situation, it is undesirable. Also, because an output above 54 dBuV/m may interfere with other transmissions in the restricted band, it is undesirable. Furthermore, because transmissions in the restricted band may include important broadcasts, such as police, fire, and other emergency transmissions, such interference may be harmful to a facility from which the illegally high transmissions occur and may be harmful to the community around which the transmissions occur.

Accordingly, there is a need for a device and method to maximize the fundamental output power of a LAN radio while maintaining output power of the radio at the third harmonic of the radios transmission frequency to be no more than 54 dBuV/m to make communication between radios robust while not interfering with neighboring radio frequency bands.

### SUMMARY OF THE INVENTION

In one embodiment, the present disclosure contemplates a high-powered ISM band radio board having an output power of not more than 54 dBuV/m at the harmonic frequencies. That high-powered ISM band radio board includes a microprocessor, a radio transceiver coupled to the microprocessor, a timer crystal coupled to the radio transceiver, and a low-pass filter coupled to the radio transceiver. A transmission and reception line extends from the radio transceiver and terminates at an antenna and a transmission line stub extends from the transmission and reception line at a first end of the stub, has a length of one-quarter of the wavelength at the third harmonic of a signal output by the radio, and is open at a second end opposite the first end.

In another embodiment, the present disclosure contemplates a high-powered ISM band radio board having an output power of not more than 54 dBuV/m at the harmonic frequencies. That high-powered ISM band radio board includes a microprocessor, a radio transceiver coupled to the microprocessor, a timer crystal coupled to the radio transceiver, and a low-pass filter coupled to the radio transceiver. A two-branched forking transmission and reception line extends from the radio transceiver, the first transmission and reception line fork terminating at an antenna and the second transmission and reception line fork having a length of one-quarter of a wavelength at the third harmonic of a signal output by the radio, the open transmission and reception line fork reducing the ISM band radio board output to not more than 54 dBuV/m.

In yet another embodiment, the present disclosure contemplates an Internet of things enabled device. That Internet of things enabled device includes a processor, a storage device coupled to the processor, memory coupled to the processor, a radio transceiver coupled to the processor, a timer crystal coupled to the radio transceiver, and a low-pass filter coupled to the radio transceiver. A transmission and reception line extends from the radio transceiver and terminates at an antenna and a transmission line stub extends from the transmission and reception line at a first end of the stub, has a length of one-quarter of a wavelength at the third harmonic of a signal output by the radio, and is open at a second end opposite the first end.

### BRIEF DESCRIPTION OF THE DRAWINGS

For the present disclosure to be easily understood and readily practiced, the present disclosure will now be described for purposes of illustration and not limitation, in connection with the following figures.

The accompanying drawings, wherein like reference numerals are employed to designate like components, are included to provide a further understanding of the present inventions, are incorporated in and constitute a part of this specification, and show embodiments of those apparatuses and methods that together with the description serve to explain those apparatuses and methods.

Various other objects, features and advantages of the invention will be readily apparent according to the following description exemplified by the drawings, which are shown by way of example only, wherein:

FIG. 1 illustrates an embodiment of a radio board;

FIG. 2 illustrates an exemplary embodiment of an improved radio board;

FIG. 3 depicts an embodiment of an Internet of things enabled device in one embodiment of the invention; and

FIG. 4 depicts an embodiment of a network in an embodiment of the present invention.

### DETAILED DESCRIPTION OF THE INVENTION

Reference will now be made in detail to certain embodiments of the present disclosure, examples of which are illustrated in the accompanying figures. It is to be understood that the figures and descriptions of the present disclosure included herein illustrate and describe elements that are of particular relevance to the present disclosure, while eliminating, for the sake of clarity, other elements found in typical radios.

Any reference in the specification to “one embodiment,” “a certain embodiment,” or any other reference to an embodiment is intended to indicate that a particular feature, structure or characteristic described in connection with the embodiment is included in at least one embodiment and may be utilized in other embodiments as well. Moreover, the appearances of such terms in various places in the specification are not necessarily all referring to the same embodiment. References to “or” are furthermore intended as inclusive so “or” may indicate one or another of the ored terms or more than one ored term

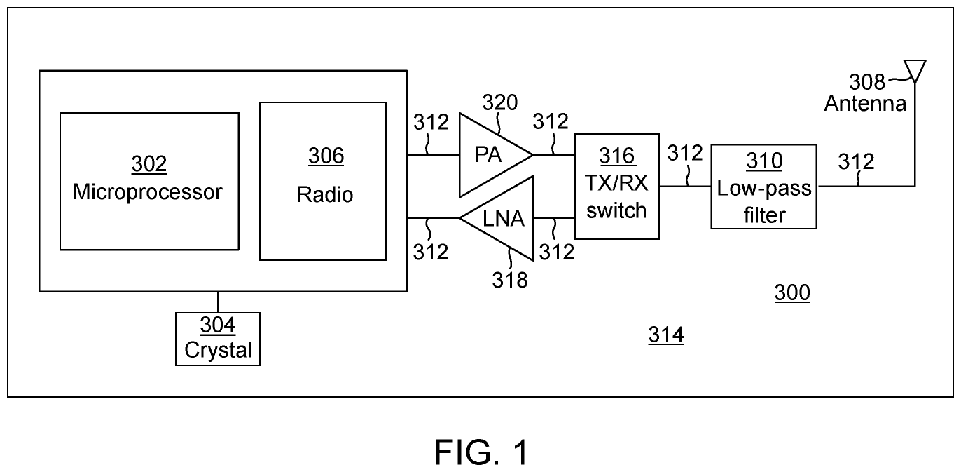

FIG. 1 illustrates an embodiment of a radio board or module 300. The radio board 300 includes a microprocessor 302, a timer crystal 304, a radio transceiver 306, and an antenna 308. The radio board or module 300 may also include a low-pass filter 310 and one or more transmission/reception lines 312.

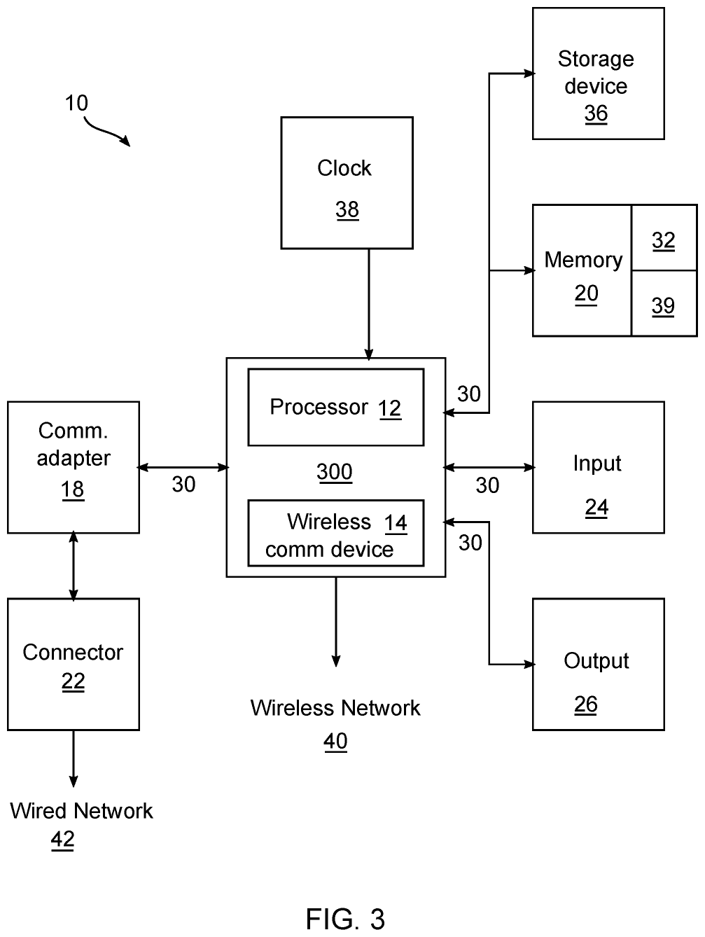

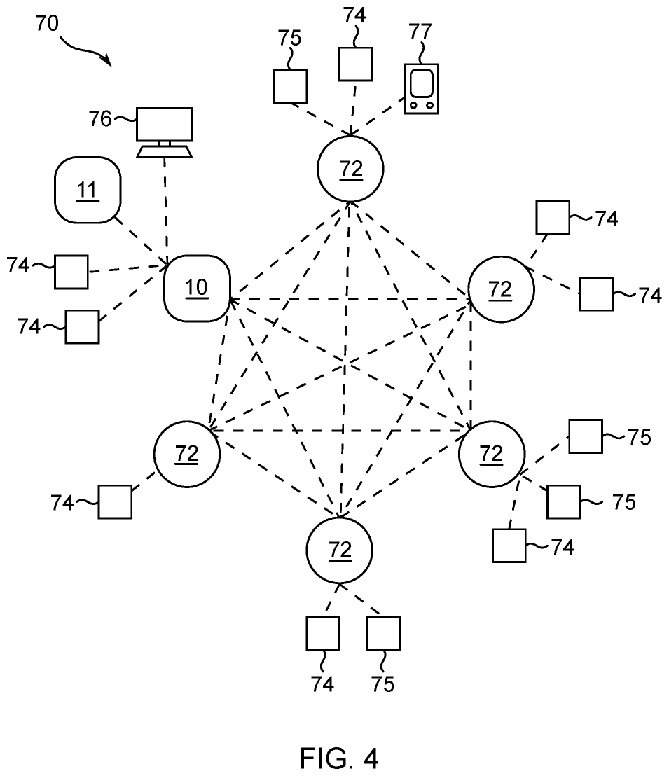

As may be seen in FIG. 3, the radio board 300 may be included in a device and may communicate with other radio boards 300 in various devices by way of a ZigBee protocol or another wireless protocol. Those other devices may include other control devices such as wireless luminaire and other networked controllers 74, manual controls such as a dimming switch 75, one or more routers 72, one or more gateways 10 and 11 (also depicted in FIG. 4), and computing devices 76 and 77.

The radio board 300 may also include circuitry to couple the various components 302, 304, 306, 308, and 310 of the radio board 300. The radio board 300 components 302, 304, 306, 308, and 310 may furthermore be mounted on a circuit board 314.

The radio board 300 circuitry may additionally include transmit (TX) and receive (RX) paths and an integrated and hard-wired media access control (MAC) permanent unique identifier.

The microprocessor 302 may be any of a variety of microprocessors, including an ARM Cortex-M3 or M4 and may be embedded on a transceiver integrated circuit. A microcontroller may be used and operate as the microprocessor 302.

The crystal timer 304 is a device that creates an electrical signal with a precise frequency. The crystal timer 304 provides a stable clock signal to the radio transceiver 306 and ensures frequency accuracy of a transmitted signal.

The radio transceiver 306 may be any of a variety of radio transceivers including a Silicon Labs EM35x, EFR32 or CSR CSR1010 model radio transceiver. The radio transceiver 306 may incorporate a radio frequency (RF) transceiver with baseband modem, the hardwired MAC, and the microprocessor 302 or a microcontroller. The radio transceiver 306 may have a single RF transmit (TX) and reception (RX) port, or may have a separate transmit output and a separate reception input operated by an external TX/RX switch 316. The radio transceiver 306 also has a clock input to receive a signal from the crystal timer 304.

The antenna 308 may be of various constructions and may, for example, take the form of an integrated trace antenna on the circuit board 314 or an external antenna connected through one or more pins or otherwise as desired on the radio board 300. There may furthermore be a common antenna 308 for both the transmit and receive functions or separate antennas for each of the transmit and receive functions.

The low-pass filter (LPF) 310 attenuates the high-frequency radio signals and prevents them from being transmitted from the radio transceiver 306. The LPF 310 perm its desired frequencies below the high-frequency cut-off to pass through the LPF 310 and be transmitted. The low-pass filter 310 may be included on the radio module between the radio transceiver 306 and the antenna 308.

Transmission/reception lines 312 are wires or conductive traces that connect the radio transceiver 306 to the antenna 308. Transmission/reception lines 312 may be arranged in various ways including a single transmission line 312 connecting the radio transceiver 306 to the antenna 308, possible through the low-pass filter 310, or a transmission line 312 and a separate reception line 312 extending from the transceiver 306 connecting at a duplex junction (such as a transmit/receive TX/RX switch 316) and a third transmission/reception line 312 connecting that junction to the antenna 308.

The transmit/receive (TX/RX) switch 316 is optional. When used, the transmit/receive (TX/RX) switch 316 switches between transmit and receive functions where the radio transceiver 306 is using separate transmit (TX) and receive (RX) circuits. The transmit/receive (TX/RX) switch 316 may be included on the radio transceiver 306 in an integrated circuit type system, connected to the TX output and RX input of the radio transceiver 306.

A low noise amplifier 318 (LNA) may be employed to amplify a received radio frequency (RF) signal. That low noise amplifier may be internal or external to an integrated circuit that includes the transceiver 306.

A power amplifier 320 (PA) may also be incorporated in the radio board 300 to amplify a signal to be transmitted from the radio board 300. The power amplifier generally delivers high efficiency, high gain, and high output power (for example the power output of the power amplifier may be equal to the signal received plus 20.0 dB) to provide an extended range and reliable transmission for nodes in a network. The power amplifier may be internal or external to an integrated circuit that includes the transceiver 306.

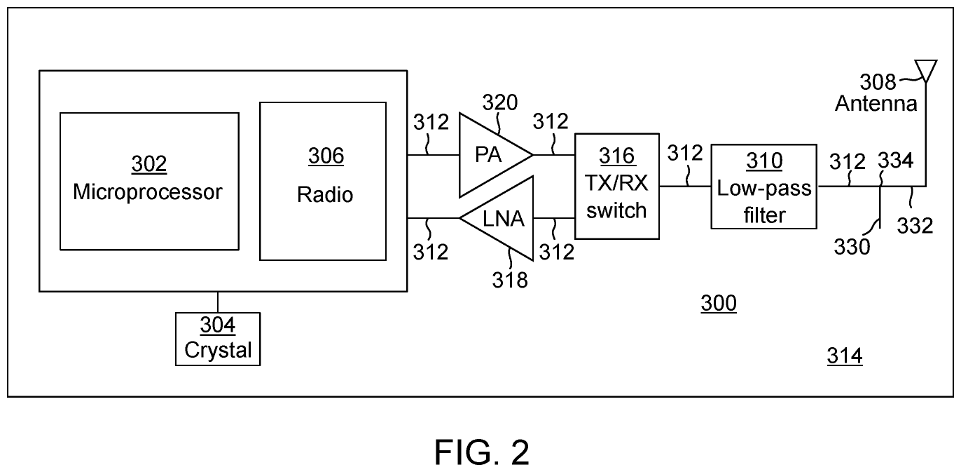

FIG. 2 illustrates an embodiment of a radio 300 that includes a transmission line stub 330. The transmission line stub 330 branches off a transmission line or a transmission and reception line 312 as illustrated in FIG. 2, extending from the low-pass filter 310 to the antenna 308. The transmission line stub 330 extends from the transmission and reception line 312 at a first end of the stub 330. A second end of the stub 330, opposite the first end where the stub 330 attaches to the transmission and reception line 312, is left open circuited.

The transmission and reception line 312 may alternately be viewed as having two branches, a first antenna branch 332 that extends from a junction 334 of the transmission and reception line 312 to the antenna 308, and a second, open-ended stub branch 330 that also extends from the junction 334 of the transmission and reception line 312.

The transmission line stub 330 has a length approximately equal to a quarter wavelength of the third harmonic frequency transmitted by the radio transceiver 306. The addition of the transmission line stub 330 having a length of a quarter wavelength of the third harmonic frequency transmitted by the radio transceiver 306 provided as an open branch on the transmission and reception line 312 attenuates the third harmonic of the radio transceiver 306 transmission.

Accordingly, by incorporating the transmission line stub 330, the radio board or module 300 may be set to a higher output power and thus achieve a higher output signal while not exceeding an output of 54 dBuV/m at the third harmonic because the transmission line stub 330 decreases the power output at the third harmonic of the radio board or module 300.

FIG. 3 illustrates an embodiment of a gateway 10 that performs network traffic management in one building control embodiment. Such a local network may be coupled to the Internet, as is shown in FIG. 4 and may be referred to as an Internet of Things (IoT) network. The gateway 10 includes a processor 12 and a wireless network communication device 14. The processor 12 and wireless communication device 14 may be combined in a controller 16, which may be a microcontroller. The gateway 10 also may include a communication adaptor 18, memory 20, a communication adaptor port or connector 22, one or more input devices 24, diagnostic output devices 26, and a clock 38.

The wireless communication device 14 may be a radio board or module 300, such as those described in connection with FIGS. 1 and 2 or, for example, a ZigBee® network communication device. The gateway 10 may use the wireless communication device 14 to facilitate communications across one or more networks, including a wireless network 40 and a wired network 42.

It should be recognized that the gateway 10 may have fewer components or more components than shown in FIG. 3. For example, if an input device 24 or output device 26 is not desired, such a device may not be included in the gateway 10.

The elements, including the processor 12, memory 20, data storage device 36, output 26, input 24, and communication adaptor 18 related to the gateway 10 may communicate by way of one or more communication busses 30. Those busses 30 may include, for example, a system bus or a peripheral component interface bus.

The memory 20 may, for example, include random-access memory (RAM), flash RAM, dynamic RAM, or read only memory (ROM) (e.g., programmable ROM, erasable programmable ROM, or electronically erasable programmable ROM) and may store computer program instructions and information. The memory 20 may furthermore be partitioned into sections including an operating system partition 32 where system operating instructions are stored, and a data partition 39 in which data is stored.

The processor 12 may be any desired processor and may be a part of a controller 16, such as a microcontroller, may be part of or incorporated into another device, or may be a separate device. The processor 12 may, for example, be an Intel® manufactured processor or another processor manufactured by, for example, AMD®, DEC®, or Oracle®. The processor 12 may furthermore execute the program instructions and process the data stored in the memory 20. In one embodiment, the instructions are stored in the memory 20 in a compressed or encrypted format. As used herein the phrase, “executed by a processor” is intended to encompass instructions stored in a compressed or encrypted format, as well as instructions that may be compiled or installed by an installer before being executed by the processor 12.

The data storage device 36 may, for example, be non-volatile battery backed static random-access memory (RAM), a magnetic disk (e.g., hard drive), optical disk (e.g., CD-ROM) or any other device or signal that can store digital information. The data storage device 36 may furthermore have an associated real-time clock 38, which may be associated with the data storage device 36 directly or through the processor 12 or controller 16. The real-time clock 38 may trigger data from the data storage device 36 to be sent to the processor 12, for example, when the processor 12 polls the data storage device 26. Data from the data storage device 36 that is to be sent across the network 40 or 42 through the processor 12 may be sent in the form of messages in packets. Those messages may furthermore be queued in or by the processor 12.

The communication adaptor 18 permits communication between the gateway 10 and other gateways 11 (depicted in FIG. 2), routers 72 (depicted in FIG. 2), devices, or nodes coupled to the communication adaptor 18 at the communication adaptor connector 22. The communication adaptor 18 may be a network interface that transfers information from a node such as a router 72, a terminal device 74 or 75 (depicted in FIG. 2), a general purpose computer 76 (depicted in FIG. 4), a user interface 77 (depicted in FIG. 4) or another gateway 11 to the gateway 10 or from the gateway 10 to a node 11, 72, 74, or 76. The communication adaptor 18 may be an Ethernet adaptor or another adaptor for another type of network communication. It will be recognized that the gateway 10 may alternately or in addition be coupled directly to one or more other devices through one or more input/output adaptors (not shown).

The input device 24 and output device 26 may couple the gateway 10 to one or more input or output devices such as, for example, one or more pushbuttons and diagnostic lights or displays. It will be recognized, however, that the gateway 10 does not necessarily need to have an input device 24 or an output device 26 to operate. Moreover, the data storage device 36 may also not be necessary for operation of the gateway 10 as data may be stored in memory, for example. Data may also be stored remotely and accessed over a network, such as the Internet.

The processor 12 may include or be attached to the real-time clock 38 such that the processor 12 may read or retrieve scheduled events from the data storage device 36 when or subsequent to real-time clock 38 indication that the scheduled time has arrived. Those retrieved scheduled events may then be transmitted across the network 40 or 42. One or more of such scheduled events may trigger messages to be sent at a time or in a cycle and, where more than one message is triggered to be sent across the network 40 or 42, those messages may form a queue. The queue may be created at the microprocessor 16.

Other devices, such as those illustrated in FIG. 4, including routers 72, and end devices 74 and 75 such as sensor nodes and actuator nodes may alternately be configured with some or all of the components discussed in connection with FIG. 3.

FIG. 4 illustrates an embodiment of a network 70 over which the radio board or module 300 may facilitate communication. The network 70 includes a gateway 10, one or any desired number of additional gateways 11, one or more routers 72, a plurality of end devices 74 and 75, and one or more general purpose computers 76 and user interfaces 77. The additional gateways 11 may be like the gateway 10 illustrated in FIG. 3, or may be of various configurations. The end devices may be actuated devices 74 such as lighting fixtures, blinds, or various other devices that are controlled by or in the network 70 and sensors 75 such as manually operated switches, light level sensors, and other ambient condition sensors.

Messages to be transmitted across the network 40, 42, or 70 may enter a queue. The queue may be a packet queue where packets making up a message are queued for transmission across one or more networks 40, 42, or 70. Messages or packets may be placed in that queue by the processor 12. Those messages and packets to be transmitted across the network may furthermore come from different places or processor 12 functions including scheduled events read from the data storage device 36 of any networked device by the processor 12 of that networked device and events or data created by any networked processor from, for example, sensed data received from a sensor 75 coupled to the network 40, 42, or 70.

The messages transmitted across the network 40, 42, or 70 may include data to be used by one or more of the receiving nodes 72 or 74 or events to be actuated at one or more of the end device receiving nodes 72, 74, or 75 such as turning a light on or off or energizing a motor on a motorized window shade or blind.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalent.

What is claimed is:

1. A high-powered ISM band radio board having an output of not more than 54 dBuV/m at the harmonics, comprising:
a microprocessor;
a radio transceiver coupled to the microprocessor;
a timer crystal coupled to the radio transceiver;
a low-pass filter coupled to the radio transceiver;
a transmission and reception line extending from the radio transceiver and terminates at an antenna; and
a transmission line stub extending from the transmission and reception line at a first end, having a length of one-quarter of wavelength of the third harmonic of a signal output by the radio, and being open at a second end opposite the first end, and operating to reduce the ISM band radio board harmonic output power to not more than 54 dBuV/m.

2. The radio board of claim 1, wherein the microprocessor, the radio transceiver, the timer crystal, and the low-pass filter are attached to a circuit board and the second transmission and reception line fork is a trace on the printed circuit board.

3. A high powered ISM band radio board having a third harmonic output power of not more than 54 dBuV/m, comprising:
a microprocessor;
a radio transceiver coupled to the microprocessor;
a timer crystal coupled to the radio transceiver;
a low-pass filter coupled to the radio-transceiver; and
a two-branched forking transmission and reception line extending from the radio transceiver, the first transmission and reception line fork terminating at an antenna and the second transmission and reception line fork having a length of one-quarter of a wavelength of a third harmonic of a signal output by the radio, the open transmission and reception line fork reducing the ISM band radio board output to not more than 54 dBuV/m.

4. The radio board of claim 3, wherein the microprocessor, the radio transceiver, the timer crystal, and the low-pass filter are attached to a circuit board and the second transmission and reception line fork is a trace on the printed circuit board.

5. An Internet of things enabled device, comprising:
a processor;
a storage device coupled to the processor;
memory coupled to the processor;
a radio transceiver coupled to the processor;
a timer crystal coupled to the radio transceiver;
a low-pass filter coupled to the radio transceiver;
a transmission and reception line extending from the radio transceiver and terminates at an antenna; and
a transmission line stub extending from the transmission and reception line at a first end, having a length of one-quarter of a wavelength of a third harmonic of a signal output by the radio, and being open at a second end opposite the first end, and operating to reduce the ISM band radio board output power of the third harmonic to not more than 54 dBuV/m.

6. The Internet of things enabled device of claim 5, further comprising an output for actuating a control device.

7. The Internet of things enabled device of claim 5, further comprising an input for receiving a control signal.

8. The Internet of things enabled device of claim 5, further comprising a communication adaptor to communicate information from the Internet of things enable device to another device on a wired network.

9. The Internet of things enabled device of claim 8, further comprising the communication adaptor communicating information from the other device on the wired network to the Internet of things enable device.

10. The Internet of things enabled device of claim 9, wherein Internet of things enabled device is a gateway.
